(19) United States
(12) Patent Application Publication
(10) Pub. No.: US 2018/0317704 A1
(43) Pub. Date: Nov. 8, 2018

(54) STOVETOP GRILL

(71) Applicant: Base Hit Innovations, LLC, Boynton Beach, FL (US)

(72) Inventor: Scott Joseph Frybarger, Bradenton, FL (US)

(21) Appl. No.: 15/586,352

(22) Filed: May 4, 2017

(51) Int. Cl. A47J 37/06; A47J 36/02

(52) U.S. Cl. CPC A47J 37/067; A47J 36/02; A47J 36/025

(57) ABSTRACT

A removable stovetop grill including a first cooking plate and a second cooking plate, each with a planar top cooking surface, a bottom stovetop-facing surface, and a lateral coupling edge, the bottom stovetop-facing surface being disposed opposite the planar top cooking surface and operably configured to face at least one stovetop burner and transfer heat from the at least one stovetop burner to the planar top cooking surface. The lateral coupling edge of each the first cooking plate and the second cooking plate are removeably couplable to one another and operably configured such that, when coupled together, the planar top cooking surfaces of the first and second cooking plates form a an effectively continuous planar cooking surface sized to cover at least two standard-sized stovetop burners for receiving heat therefrom.

### FIELD OF THE INVENTION

The present invention relates generally to cooking devices, and, more particularly, relates to a removable stovetop grill with a cooking surface for at-home grilling.

### BACKGROUND OF THE INVENTION

Hibachi grilling, a traditional form of Japanese cooking, has gained increasing popularity in North American restaurants. In such restaurants, the hibachi grill typically includes a gas-heated hot plate permanently integrated into a table around which restaurant goers sit as spectators while the hibachi grilling professional cooks the food on the hot plate. The cooking surface of the hot plate is typically flat to achieve uniform heating and rather large to permit grilling a large amount of food thereon. Accordingly, Hibachi grilling is typically reserved for restaurants and not for residential home grilling because portable residential hot plates, woks, pans, and other residential cooking devices are typically sized for one burner. This greatly limits the type of cooking styles that can be performed in most residential homes with conventional gas or electric stoves. Even in restaurants, a hibachi grill, or any large cooking surface for high capacity cooking, is generally a fixed structure, permanently consuming stovetop space.

Therefore, a need exists to overcome the problems with the prior art as discussed above.

### SUMMARY OF THE INVENTION

The invention provides a stovetop grill that overcomes the hereinafore-mentioned disadvantages of the heretofore-known devices and methods of this general type.

With the foregoing and other objects in view, there is provided, in accordance with the invention, a removable stovetop grill including a first cooking plate and a second cooking plate, each with a planar top cooking surface portion, a bottom stovetop-facing surface, and a lateral coupling edge, the bottom stovetop-facing surface being disposed opposite the planar top cooking surface portion and operably configured to face at least one stovetop burner and transfer heat from the stovetop burner to the planar top cooking surface portion; and the lateral coupling edge of each the first cooking plate and the second cooking plate being removeably couplable to one another and operably configured such that, when coupled together, the planar top cooking surface portions of the first and second cooking plates form an effectively continuous planar cooking surface sized to cover at least two standard-sized stovetop burners for receiving heat therefrom.

In accordance with another feature of the present invention, for each of the first and the second cooking plates, the planar top cooking surface portion defines a recessed channel portion at a periphery of the planar top cooking surface portion, the recessed channel portion being operably configured to collect cooking fluids within the recessed channel portion.

In accordance with yet another feature of the present invention, the lateral coupling edge of the first cooking plate is sized and shaped to matingly engage the lateral coupling edge of the second cooking plate.

In accordance with a further feature, an embodiment of the present invention further includes at least one groove defined by a latch arm coupled to a periphery of the first cooking plate; and at least one projecting portion extending from a periphery of the second cooking plate, the groove sized and shaped to matingly receive the projecting portion of the second cooking plate to selectively fasten the first cooking plate to the second cooking plate when the lateral coupling edge of the first cooking plate is matingly engaged to the lateral coupling edge of the second cooking plate.

In accordance with yet a further feature, an embodiment of the present invention further includes a ledge extending laterally outwardly beyond the lateral coupling edge of the second cooking plate and a groove recessed within the ledge; and a lip portion extending laterally along a periphery of the bottom stovetop-facing surface of the first cooking plate, the groove and lip portion disposed to matingly engage one another when the first cooking plate and the second cooking plate are coupled together to form the continuous planar cooking surface.

In accordance with yet another feature, an embodiment of the present invention further includes for each of the first and second cooking plates, a perimeter sidewall extending along at least a portion of a perimeter edge of the respective cooking plate and extending downwardly away from the bottom stovetop-facing surface toward the stovetop burner.

In accordance with a further feature of the present invention, the perimeter sidewall is a discontinuous perimeter sidewall defining at least one vent opening operable to release heated air between the stovetop burner and the bottom stovetop-facing surface of the respective cooking plate into an outside atmosphere.

In accordance with yet a further feature of the present invention, each of the first and second cooking plates is made of a heat-conductive material; and the perimeter sidewall is made of a heat-resistant material.

In accordance with another feature of the present invention, each of the first cooking plate and the second cooking plate is handle-free.

In accordance with another feature, an embodiment of the present invention further includes for each of the first and second cooking plates, a perimeter sidewall extending along at least a portion of a perimeter of the respective cooking plate and extending downwardly away from the bottom stovetop-facing surface and toward the stovetop burner, the stovetop burner having raised heating elements and the perimeter sidewall disposed to at least partially surround the raised heating elements so as to restrict a movement of the respective cooking plate in a plane defined by the continuous planar cooking surface when the respective cooking plate is disposed over the stovetop burner.

In accordance with yet another feature of the present invention, each of the first and second cooking plates is made of a metallic material.

In accordance with yet another feature of the present invention, for each of the first and second cooking plates, the planar top cooking surface portion is coated with a food-grade solution so as to form a non-stick cooking surface.

In accordance with an additional feature of the present invention, the first cooking plate and the second cooking plate are each sized and shaped such that, when coupled together, the continuous planar cooking surface spans over all of the stovetop burners of a standard residential stove.

In accordance with yet another feature of the present invention, the planar top cooking surface portion of each of the first cooking plate and the second cooking plate are sized and shaped to cover substantially one-half of the stovetop burners of a standard residential stovetop.

In accordance with another feature, an embodiment of the present invention provides a stovetop hibachi grill removable from a stovetop and including a first cooking plate and a second cooking plate, each with a planar top cooking surface portion, a bottom stovetop-facing surface, a lateral coupling edge, and a perimeter sidewall; and wherein the bottom stovetop-facing surface is disposed opposite the planar top cooking surface portion; the perimeter sidewall extends along at least a portion of a perimeter edge of the respective cooking plate; the perimeter sidewall extends downwardly away from the bottom stovetop-facing surface toward at least one stovetop burner so as to form support feet for the grill; and the lateral coupling edge of each the first cooking plate and the second cooking plates are removeably couplable to one another and operably configured such that, when coupled together, the planar top cooking surface portions of the first and second cooking plates form an effectively continuous planar cooking surface sized to cover at least two standard-sized stovetop burners for receiving heat therefrom.

In accordance with a further feature of the present invention, the perimeter sidewall is a discontinuous perimeter sidewall defining at least one vent opening operable to release heated air between the stovetop burner and the bottom stovetop-facing surface of the respective cooking plate into an outside atmosphere.

In accordance with another feature of the present invention, the perimeter sidewall is operable to restrict movement of the grill in a plane defined by the continuous planar cooking surface when the grill is disposed on a gas stovetop with raised heating elements.

In accordance with yet another feature of the present invention, for each of the first and the second cooking plates, the planar top cooking surface portion defines a recessed channel portion at a periphery of the planar top cooking surface portion, the recessed channel portion being operably configured to collect cooking fluids within the recessed channel portion.

In accordance with yet another feature, yet another embodiment of the present invention includes at least one groove defined by a latch arm coupled to a periphery of the first cooking plate; and at least one projecting portion extending from a periphery of the second cooking plate, the groove sized and shaped to matingly receive the projecting portion of the second cooking plate to selectively fasten the first cooking plate to the second cooking plate.

In accordance with yet another feature, an embodiment of the present invention further includes a ledge extending laterally outwardly beyond the lateral coupling edge of the second cooking plate and a groove recessed within the ledge; and a lip portion extending laterally along a periphery of the bottom stovetop-facing surface of the first cooking plate, the groove and lip portion disposed to matingly engage one another when the first cooking plate and the second cooking plate are coupled together to form the continuous planar cooking surface.

Although the invention is illustrated and described herein as embodied in a stovetop grill, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the stovetop grill.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a downward-looking top perspective view of a stovetop grill, in a coupled configuration, in accordance with the present invention;

FIG. 2 is a top plan view of the stovetop grill of FIG. 1 in accordance with the present invention;

FIG. 3 is a bottom perspective view of the stovetop grill of FIG. 1 in accordance with the present invention;

FIG. 4 is a bottom perspective view of the stovetop grill of FIG. 1, in an uncoupled configuration, in accordance with the present invention;

FIG. 5 is a side elevational view of the stovetop grill of FIG. 1, in a coupled configuration, in accordance with the present invention;

FIG. 6 is a cross-sectional side elevational view of the stovetop grill of FIG. 1, in an uncoupled configuration, in accordance with the present invention;

FIG. 7 is a partial, enlarged side elevational view of a coupling area of the stovetop grill of FIG. 1, with a first plate portion being fastened to a second plate portion, in accordance with the present invention;

FIG. 8 is a partial, enlarged side elevational view of the coupling area of the stovetop grill of FIG. 1, with the first plate portion being unfastened from the second plate portion, in accordance with the present invention;

FIG. 9 is a downward-looking perspective view of a hibachi stovetop grill, disposed on a gas stovetop in a coupled configuration, in accordance another exemplary embodiment of the present invention; and

FIG. 10 is a downward-looking perspective view of the hibachi stovetop grill of FIG. 9, disposed on the gas stovetop in an uncoupled configuration, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient removable stovetop grill. Embodiments of the invention provide for a high capacity stovetop grill assembly with at least two hot plates removeably couplable to one another to provide a planar top cooking surface sized for cooking over more than one stovetop burner. In addition, embodiments of the invention provide for a recessed channel formed in a periphery of the planar top cooking surface of each of the hot plates to collect cooking fluids, such as oil and sauce. Additional embodiments of the invention include a bottom perimeter wall providing stable support for the stovetop grill on a flat surface and also defining at least one vent opening for releasing heat from the stovetop burners.

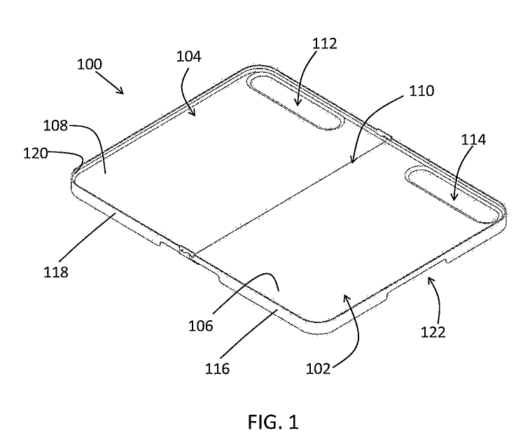

Referring now to FIGS. 1-4, one embodiment of the present invention is shown, respectively, in a downward-looking top perspective view, a top plan view, a bottom perspective view, and a bottom perspective view of an uncoupled configuration. FIGS. 1-4 show several advantageous features of the present invention, but, as will be described below, the invention can be provided in several shapes, sizes, combinations of features and components, and varying numbers and functions of the components. The first example of a removable stovetop grill 100, as shown in FIG. 1, includes a first cooking plate 102 and a second cooking plate 104 removeably couplable to one another.

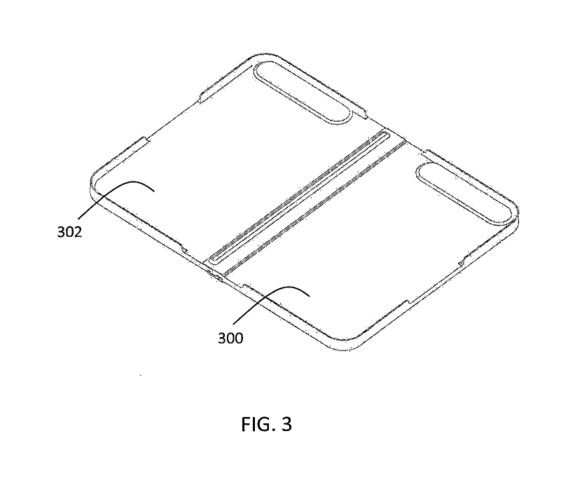

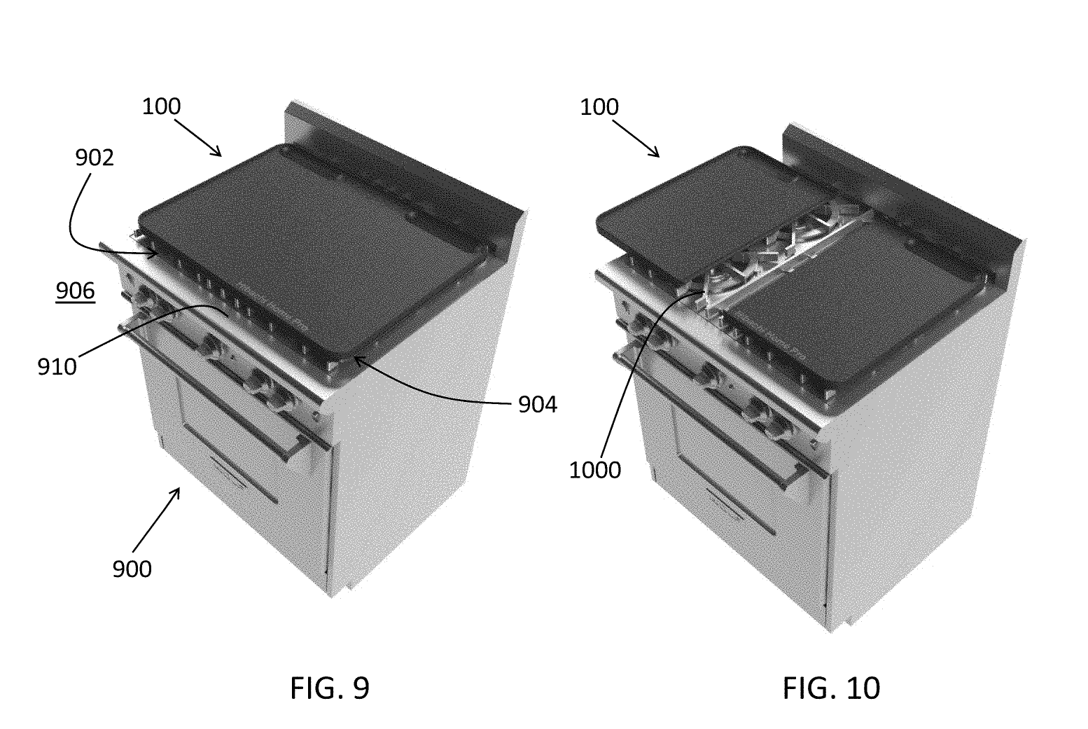

Each of the first cooking plate 102 and the second cooking plate 104 includes a planar top cooking surface portion 106, 108 for cooking food thereon and a respective bottom stovetop-facing surface 300, 302, shown in FIG. 3, for transferring heat from the stovetop burners to the planar top cooking surface portions 106, 108. As is apparent from FIGS. 1-4 in conjunction with FIGS. 9 and 10, showing exemplary uses of the stovetop grill 100 with a stove 900, the bottom stovetop-facing surfaces 300, 302 are disposed opposite the respective planar top cooking surface portions 106, 108. Further, the bottom stovetop-facing surfaces 300, 302 are operably configured to directly face the stovetop burners 902 in use to transfer heat from the stovetop burners 902 to the respective top planar cooking surface portions 106, 108.

Accordingly, both the first cooking plate 102 and the second cooking plate 104, including the respective planar top cooking surface portions 106, 108 and the respective bottom stovetop-facing surfaces 300, 302 are made of a heat-conductive material, such as, a metallic material. The metallic material may be, for example, aluminum, steel, or cast iron.

In a further embodiment, the planar top cooking surface portions 106, 108 may be coated with a food-grade solution so as to form a non-stick cooking surface. In an alternative embodiment, the top planar cooking surface portions 106, 108 may be devoid of such non-stick solution coating and may be configured to instead rely primarily on cooking oils to avoid food sticking to the cooking surface portions 106, 108.

In one embodiment, the planar top cooking surface portion 106 or 108 of each of the first cooking plate 102 and the second cooking plate 104 are sized and shaped to cover substantially one-half of the stovetop burners 902 of a standard residential stovetop 904, as shown in FIGS. 9 and 10. In such embodiments, one cooking plate 102 or 104 may be used to cook food on a continuous planar cooking surface 106 or 108 that spans over more than one stovetop burner 902 and, more specifically, in some embodiments, over half of the stovetop burners 902 on the stove 900. Alternatively, at the user's discretion, the two cooking plates 102 and 104 may be selectively coupled and fastened together to provide a more high capacity continuous planar cooking surface 106, 108 that spans over all of the stovetop burners 902 on the standard residential stove 900. Stated another way, the first cooking plate 102 and the second cooking plate 104 may each be sized and shaped such that, when coupled together, the continuous planar cooking surface 106, 108 of the assembled stovetop grill 100 spans over all of the stovetop burners 902 of the standard residential stove 900. Accordingly, the stovetop grill 100 can provide a selectable size removable cooking surface for flexibility of use.

Although persons of ordinary skill in the art should know what the dimensions and dimension ranges are for standard residential stoves, the applicant submits that one of the most common stove widths is 30 inches, but standard widths may vary from 20 inches to 40 inches, more or less. Additionally, a stove depth that is considered common for residential stoves is 25 inches. In a preferred embodiment, the stovetop grill 100 may be sized for use with the most common residential stoves of a likely purchasing consumer, which is within the skill set of a person of ordinary skill in the art.

In one embodiment, the planar top cooking surface portions 106, 108 may each be sized and shaped to, when the plates 102, 104 are coupled together, form a continuous planar cooking surface 106, 108 sized to cover at least two standard-sized stovetop burners 902 for receiving heat therefrom. Stated another way, the planar top cooking surface portions 106, 108 may, when coupled together, form an effectively continuous planar cooking surface sized to cover at least two standard-sized stovetop burners 902. In a further embodiment, the planar top cooking surface portions 106, 108 may each be sized and shaped to, when the plates 102, 104 are coupled together, form a continuous planar cooking surface 106, 108 sized to cover at least four standard-sized stovetop burners 902. In yet another embodiment, the planar top cooking surface portions 106, 108 may each be sized and shaped outside of these ranges; yet should still be sized and shaped to span over more than one standard-sized stovetop burner 902 for high capacity stovetop grilling. The sizes for standard residential stovetop burners are known by those of ordinary skill in the art and therefore will not be discussed in detail herein.

As used herein, the terms “continuous planar cooking surface” and “effectively continuous planar cooking surface” are intended to indicate a cooking surface that is substantially flat along substantially its entire length, without interruption, or with very nominal interruption. Stated yet another way, the terms “continuous planar cooking surface” and “effectively continuous planar cooking surface” are intended to indicate the cooking plates being mated together to minimize the junction. For example, FIGS. 1 and 9 clearly show a flat cooking surface with a nominal space/crack 110 where the two plates 102, 104 meet when coupled together. The nominal space 110 is preferably formed as a watertight seal that permits cooking food over the space 110 without cooking fluids leaking onto a stovetop 904. “Watertight,” as used herein, means a barrier that prevents fluids on the top surface from reaching the burners below; it does not require an absence of all fluids, but should prevent penetration of most fluids produced while cooking.

In a preferred embodiment, the shape of each of the cooking plates 102, 104 corresponds to a shape of at least a portion of the stovetop 904 so as to substantially utilize the stovetop burners 902 as a heating source, while providing high capacity cooking. For example, in one embodiment, as conventional stovetops are rectangular in shape, each of the cooking plates 102, 104 may be rectangular-shaped. In another embodiment, when each of the cooking plates 102, 104 are coupled together they may form a rectangular-shaped cooking surface, as shown in FIG. 1. In alternative embodiments, the cooking plates 102, 104 may be formed as other shapes and sizes.

It should be noted that although FIGS. 9 and 10 illustrate use of the stovetop grill 100 over a gas stove with raised heating elements 1000, the stovetop grill 100 may also be used on electric stovetops with, for example, a flat glass cooktop, or other types of stoves.

Referring again primarily to FIGS. 1-4, each of the planar top cooking surface portions 106, 108 may define a corresponding recessed channel portion 112, 114. The recessed channel portions 112, 114 may be disposed to provide a recessed storage area within the corresponding cooking plate 102, 104 to collect oils and sauce for cooking and flavoring the food. The recessed channel portions 112, 114 may each be elongated recessed channel portions to maximize the storage space for such cooking oils and sauces. In one preferred embodiment, to maximize the uninterrupted continuous cooking surface 106, 108 of the stovetop grill 100, the recessed channel portions 112, 114 may be defined at a periphery of the planar top cooking surface portions 106, 108, as illustrated in the exemplary embodiment depicted in FIG. 1.

The recessed channel portions 112, 114 may be made of the same material as the planar top cooking surface portions 106, 108 and, therefore, may also be heat-conductive.

In one embodiment, the recessed channel portions 112, 114 may be oval-shaped, as in the exemplary embodiment shown in FIG. 1. In other embodiments, the recessed channel portions 112, 114 may be other shapes, such as, for example, rectangular-shaped. In one embodiment, the recessed channel portions 112, 114 may be considered bowl-shaped. In other words, the recessed channel portions 112, 114 may have a generally concave shape with an open top, like a bowl. In alternative embodiments, the recessed channel portions 112, 114 may define a rectilinear storage area, but should still have an open top for accessing fluids stored therein. In further embodiments, a cover may be provided for the open top to prevent food being cooked from accidentally contaminating the storage area.

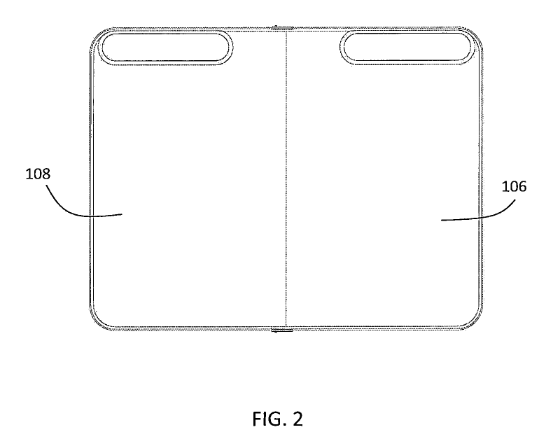

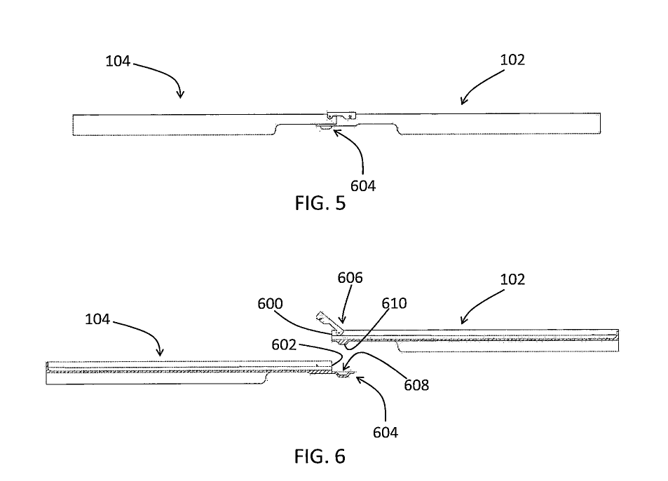

Referring now primarily to FIGS. 2-8, the selective coupling and fastening of the cooking plates 102, 104 to form the continuous cooking surface 106 and 108 of the stovetop grill 100 will now be discussed.

In one embodiment, each of the cooking plates 102, 104 may be configured for a mating coupling arrangement. In a further embodiment, each of the cooking plates 102, 104 may have a corresponding lateral coupling edge 600, 602, as shown in FIG. 6. Each lateral coupling edge 600, 602 may be removeably couplable to one another so as to couple the cooking plates 102, 104 to one another at the edges 600, 602. Stated another way, the lateral coupling edge 600 of the first cooking plate 102 may be sized and shaped to matingly engage the lateral coupling edge 602 of the second cooking plate 104. In the exemplary embodiment, the lateral coupling edge 600, 602 includes a flat peripheral edge surface. In other embodiments, the lateral coupling edge 600, 602 may be sized and shaped with other mating configurations. Importantly, when the coupling edges 600, 602 are coupled together they form a uniform, continuous cooking surface 106, 108 for high capacity hibachi grilling, as can be seen in FIG. 2.

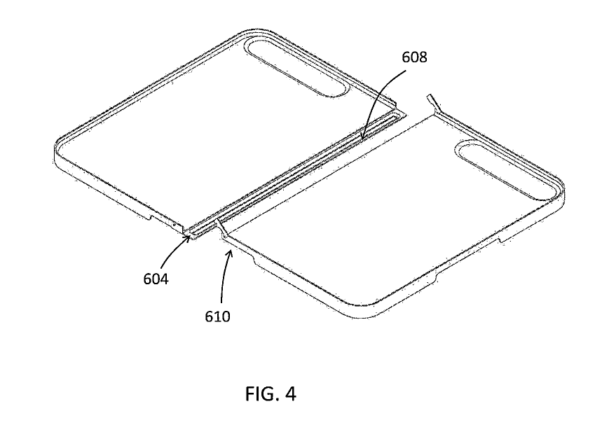

In one embodiment, the stovetop grill 100 may further includes a ledge 604 extending laterally outwardly beyond the lateral coupling edge 602 of the second cooking plate 104, as can be seen in FIGS. 4 and 6. The ledge 604 may be a support member for the first cooking plate 102 when the plates 102, 104 are coupled together. In other words, in one embodiment, a peripheral portion 606 of the first cooking plate 102 may rest on and be supported by the ledge 604 of the second cooking plate 104 when matingly coupled together in a coupled/assembled configuration.

In a further embodiment, the stovetop grill 100 may include a groove 608 recessed within the ledge 604, as can be seen in FIGS. 4 and 6. The groove 608 on the second cooking plate 104 may be sized and shaped to mate with a corresponding lip portion 610 on the first cooking plate 102 to more securely couple the two plates together 102, 104. In one embodiment, the lip portion 610 may extend laterally along the peripheral portion 606 of the first cooking plate 102. Stated another way, the lip portion 610 may be considered an elongated projecting portion extending outwardly from and laterally along a periphery of the bottom stovetop-facing surface 300 of the first cooking plate 102. The groove 608 and the lip portion 610 may be disposed to matingly engage one another when the first cooking plate 102 and the second cooking plate 104 are coupled together to form the continuous planar cooking surface 106, 108. Accordingly, when cooking on the continuous planar cooking surface 106, 108 in the coupled/assembled configuration of the stovetop grill 100 the groove 608 and the lip portion 610 work together to retain the plates 102, 104 together resisting user cooking forces, which may otherwise tend to uncouple the plates 102, 104 from one another. In alternative embodiments, the cooking plates 102, 104 may not include the groove 608 and the lip portion 610, but should include one or more fastening members to secure the plates 102, 104 together.

It should be understood that although the groove 608 and the ledge 604 are described herein as being associated with the second cooking plate 104 and the lip portion 610 with the first cooking plate 102, alternative embodiments may be provided with the groove 608 and the ledge 604 on the first cooking plate 102 and the lip portion 610 on the second cooking plate 104, and other such variations.

Advantageously, the groove 608 may also, in some embodiments, serve as a fluid collection point for fluids that may leak through the crack 110 between the plates 102, 104, as an additional safety mechanism so as to avoid oil and fluid from contacting the burners 902, which is an undesirable condition. In preferred embodiments though, the space 110 between the plates 102, 104 when coupled together is watertight to avoid such inadvertent leaking or dripping onto the burners 902.

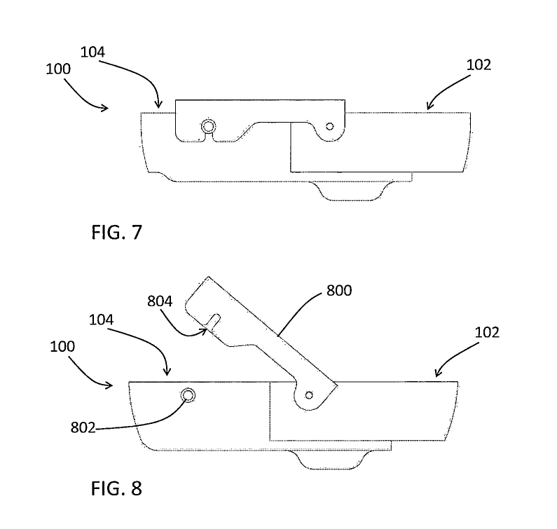

Referring now primarily to FIGS. 7-8, an exemplary fastening mechanism is shown in a partial, enlarged view of the coupling area of the stovetop grill 100, in a fastened configuration and a partial, enlarged view of the coupling area in an unfastened configuration, respectively. The exemplary fastening mechanism may include a latch arm 800 and at least one projecting portion 802. In one embodiment, the latch arm 800 may be coupled to a periphery of the first cooking plate 102 and may define at least one latch arm groove 804. The latch arm groove 804 may be sized and shaped to matingly receive the projecting portion 802 on the second cooking plate 104 to selectively fasten the second cooking plate 104 to the first cooking plate 102, as shown in FIGS. 7 and 8. The projecting portion 802 may extend outwardly from a periphery of the second cooking plate 104. In one embodiment, the latch arm groove 804 may be sized slightly smaller than the projecting portion 802 to provide a tight friction fit so as to securely fasten the cooking plates 102, 104 together in the coupled configuration. In alternative embodiments, there may be provided on the stovetop grill 100 yet other types and forms of fasteners to secure the cooking plates 102, 104 together in the coupled configuration.

Referring again primarily to FIGS. 1, 3, 9, and 10, each of the first cooking plate 102 and the second cooking plate 104 may include a perimeter sidewall 116, 118. The perimeter sidewall 116, 118 may extend downwardly away from the corresponding bottom stovetop-facing surface 300, 302 toward the stovetop burners 902. The perimeter sidewall 116, 118 may also extend along at least a portion of a perimeter edge of the corresponding cooking plate 102, 104. The perimeter sidewall 116, 118 may be considered a support structure for the cooking plates 102, 104 for embodiments where the stovetop grill 100 rests on a flat stovetop surface when in use over the stovetop burners 902. Stated another way, the perimeter sidewall 116, 118 may form support feet for the stovetop grill 100. Accordingly, in some embodiments, the perimeter sidewall 116, 118 has a flat bottom surface for resting on a flat stovetop surface.

In one embodiment, the perimeter sidewall 116, 118 may be operable to restrict movement of the stovetop grill 100 in a plane defined by the continuous planar cooking surface 106, 108 when the assembled stovetop grill 100 is disposed on a gas stovetop with raised heating elements 1000, as can be seen in FIGS. 9 and 10. In other words, in some embodiments, the perimeter sidewalls 116, 118 may be arranged to surround the raised heating elements 1000 so as to restrict a movement of the stovetop grill 100 so that when the user applies cooking movement forces on the cooking plates 102, 104 the stovetop grill 100 does not easily slide out of place.

In one embodiment, the perimeter sidewall 116, 118 may be made of a heat-resistant material, while the heating 300, 302 and cooking surfaces 106, 108 of the cooking plates 102, 104 are made of a heat-conductive material. The heat-resistant material on the perimeter sidewall 116, 118 may provide a safety barrier against heat exposure due to accidental skin contact with the perimeter sidewall 116, 118. Because the perimeter is the most likely point of accidental skin contact, such feature may provide an advantageous safety benefit.

In alternative embodiments, the perimeter sidewall 116, 118 may be made of a heat-conductive material that is the same or similar to the heat-conductive material of the heating 300, 302 and cooking surface portions 106, 108 of the cooking plates 102, 104. In some embodiments, it may be more cost efficient for the cooking plates 102, 104 (including the perimeter sidewalls 116, 118) to be constructed of the same material.

In one embodiment, the perimeter sidewall 116, 118 may be formed as a discontinuous perimeter sidewall 116, 118 defining at least one vent opening 122. In a further embodiment, the perimeter sidewall 116, 118 may each define at least two vent openings 122 at a periphery of the stovetop grill 100. In yet further embodiments, the perimeter sidewall 116, 118 may each define a plurality of vent openings 122 at a periphery of the stovetop grill 100. The vent openings 122 may be operable to release heated air (between the stovetop burners 902 and the bottom stovetop-facing surface 300, 302 of the respective cooking plate 102, 104) into the outside atmosphere 906. In some embodiments, the heated air would otherwise be trapped between the cooking plates 102, 104 and the stovetop burners 902 without the vent openings 122; particularly in embodiments where the perimeter sidewall 116, 118 is of a height sufficient to contact the flat surfaces 910 surrounding the stovetop burners 902 to form an enclosure over the stovetop burners 902. For example, resting the perimeter sidewall 116, 118 on a flat glass cooking top (not shown) would form an enclosure, except for the vent openings 122 that release the heated air into the outside environment 906.

Preferred embodiments of the stovetop grill 100 are configured to provide a flat high capacity cooking surface, inventively designed for easy, convenient, removable use with standard residential stovetops. Unlike most residential cooking devices, the first cooking plate 102 and the second cooking plate 104 are preferably handle-free cooking devices. Accordingly, the first cooking plate 102 and the second cooking plate 104 may include other retention features to assist with keeping the stovetop grill 100 in a stationary position over the stovetop burners 902, such as the perimeter sidewall 116, 118 as explained herein above, but should preferably be devoid of a handle.

In one embodiment, the perimeter sidewall 116, 118 may nominally extend in an upward direction away from the planar top cooking surface 106, 108 to provide an upper perimeter sidewall 120. In a further embodiment, the upper perimeter sidewall 120 may be fairly nominal in height, being less than 1 inch in height. In yet another embodiment, the upper perimeter sidewall 120 may be less than 0.5 inches in height. In yet other embodiments, the upper perimeter sidewall 120 may have a height that is outside of these ranges. Because of the relatively large flat cooking surface provided by the stovetop grill 100 in some embodiments, upper perimeter sidewalls 120 may not be required in order to retain the cooked items therein, as with traditional pans.

A novel and efficient removable stovetop grill has been disclosed that, in some embodiments, provides for a high capacity stovetop grill assembly with at least two hot plates removeably couplable to one another to provide a planar top cooking surface sized for cooking over more than one stovetop burner. In addition, embodiments of the invention provide for a recessed channel formed in a periphery the planar top cooking surface of each of the hot plates to collect cooking fluids, such as oil and sauce. Additional embodiments of the invention include a bottom perimeter wall providing stable support for the stovetop grill on a flat surface and also defining at least one vent opening for releasing heat from the stovetop burners. In the description herein above, the exemplary stovetop grill includes two cooking plates; however, it should be understood that in some embodiments, the stovetop grill may itself be one large hot plate, or, alternatively, may, in other embodiments, include more than two separate hot plates couplable to one another to form a larger uniform cooking surface. Further, some embodiments may include non-planar cooking surfaces, such as parallel ridges.

1. A removable stovetop grill comprising:
a first cooking plate and a second cooking plate, each with a planar top cooking surface portion, a bottom stovetop-facing surface, and a lateral coupling edge with a flat peripheral edge surface, the bottom stovetop-facing surface being disposed opposite the planar top cooking surface portion and operably configured to face at least one stovetop burner and transfer heat from the at least one stovetop burner to the planar top cooking surface portion;
the first cooking plate having a lip portion extending laterally along a periphery of the lateral coupling edge beyond the flat peripheral edge, along the bottom stovetop-facing surface of the first cooking plate and below the planar top cooking surface portion of the first cooking plate; and
wherein the planar top cooking surface of the second plate ends at the flat peripheral edge surface of the second cooking plate, wherein the lateral coupling edge of the second cooking plate is configured to extend over the lip portion of the first cooking plate such that the flat peripheral edge surface of the first cooking plate is against the flat peripheral edge surface of the second cooking plate, and wherein the first and second cooking plates comprise engagement features that engage each other to cause a fluid seal along the flat peripheral edge surfaces, and wherein the planar top cooking surfaces of the first and second cooking plates form continuous planar cooking surface that is sized to cover at least two standard-sized residential stovetop burners.

2. The removable stovetop grill in accordance with claim 1, wherein:
for each of the first and the second cooking plates, the planar top cooking surface portion defines a recessed channel portion at a periphery of the planar top cooking surface portion, the recessed channel portion being operably configured to collect cooking fluids within the recessed channel portion.

3. (canceled)

4. The removable stovetop grill in accordance with claim 1, wherein the engagement features comprise:
at least one groove defined by a latch arm coupled to the periphery of the first cooking plate at a side of the first cooking plate; and
at least one projecting portion extending from the periphery of the second cooking plate at a side of the second cooking plate, the at least one groove sized and shaped to matingly receive the at least one projecting portion of the second cooking plate to selectively fasten the first cooking plate to the second cooking plate when the lateral coupling edge of the first cooking plate is matingly engaged to the lateral coupling edge of the second cooking plate.

5. (canceled)

6. The removable stovetop grill in accordance with claim 1, further comprising:
for each of the first and second cooking plates, a perimeter sidewall extending along at least a portion of a perimeter edge of the respective cooking plate and extending downwardly away from the bottom stovetop-facing surface toward the at least one stovetop burner.

7. The removable stovetop grill in accordance with claim 6, wherein:
the perimeter sidewall is a discontinuous perimeter sidewall defining at least one vent opening operable to release heated air between the at least one stovetop burner and the bottom stovetop-facing surface of the respective cooking plate into an outside atmosphere.

8. The removable stovetop grill in accordance with claim 6, wherein:
each of the first and second cooking plates is made of a heat-conductive material; and
the perimeter sidewall is made of a heat-resistant material.

9. The removable stovetop grill in accordance with claim 1, wherein:
each of the first cooking plate and the second cooking plate is handle-free.

10. The removable stovetop grill in accordance with claim 1, further comprising:
for each of the first and second cooking plates, a perimeter sidewall extending along at least a portion of a perimeter of the respective cooking plate and extending downwardly away from the bottom stovetop-facing surface and toward the at least one stovetop burner, the at least one stovetop burner having raised heating elements and the perimeter sidewall disposed to at least partially surround the raised heating elements so as to restrict a movement of the respective cooking plate in a plane defined by the continuous planar cooking surface when the respective cooking plate is disposed over the at least one stovetop burner.

11. The removable stovetop grill in accordance with claim 1, wherein:
each of the first and second cooking plates is made of a metallic material.

12. The removable stovetop grill in accordance with claim 1, wherein:
for each of the first and second cooking plates, the planar top cooking surface portion is coated with a food-grade solution so as to form a non-stick cooking surface.

13. The removable stovetop grill in accordance with claim 1, wherein:
the first cooking plate and the second cooking plate are each sized and shaped such that, when coupled together, the continuous planar cooking surface spans over all of the stovetop burners of a standard residential stove.

14. The removable stovetop grill in accordance with claim 1, wherein:
the planar top cooking surface portion of each of the first cooking plate and the second cooking plate are sized and shaped to cover substantially one-half of the stovetop burners of a standard residential stovetop.

15. A stovetop hibachi grill removable from a stovetop comprising:
a first cooking plate and a second cooking plate, each with a planar top cooking surface portion, a bottom stovetop-facing surface, a lateral coupling edge having a flat peripheral edge surface, and a perimeter sidewall; and
wherein:
the bottom stovetop-facing surface is disposed opposite the planar top cooking surface portion;
the perimeter sidewall extends along at least a portion of a perimeter edge of the respective cooking plate;
the perimeter sidewall extends downwardly away from the bottom stovetop-facing surface toward at least one stovetop burner so as to form support feet for the grill; and
the first cooking plate having a lip portion extending laterally along a periphery of the lateral coupling edge beyond the flat peripheral edge surface, along the bottom stovetop-facing surface of the first cooking plate and below the planar top cooking surface portion of the first cooking plate; and
wherein the planar top cooking surface of the second plate ends at the flat peripheral edge surface of the second cooking plate, wherein the lateral coupling edge of the second cooking plate is configured to extend over the lip portion of the first cooking plate such that the flat peripheral edge surface of the first cooking plate is against the flat peripheral edge surface of the second cooking plate, and wherein the first and second cooking plates comprise engagement features that engage each other to cause a fluid seal along the flat peripheral edge surfaces, and wherein the planar top cooking surfaces of the first and second cooking plates form a continuous planar cooking surface that is sized to cover at least two standard-sized residential stovetop burners.

16. The stovetop hibachi grill in accordance with claim 15, wherein:
the perimeter sidewall is a discontinuous perimeter sidewall defining at least one vent opening operable to release heated air between the at least one stovetop burner and the bottom stovetop-facing surface of the respective cooking plate into an outside atmosphere.

17. The stovetop hibachi grill in accordance with claim 15, wherein:
the perimeter sidewall is operable to restrict movement of the grill in a plane defined by the continuous planar cooking surface when the grill is disposed on a gas stovetop with raised heating elements.

18. The stovetop hibachi grill in accordance with claim 15, wherein:
for each of the first and the second cooking plates, the planar top cooking surface portion defines a recessed channel portion at a periphery of the planar top cooking surface portion, the recessed channel portion being operably configured to collect cooking fluids within the recessed channel portion.

19. The stovetop hibachi grill in accordance with claim 15, further comprising:
at least one groove defined by a latch arm coupled to a periphery of the first cooking plate; and
at least one projecting portion extending from a periphery of the second cooking plate, the at least one groove sized and shaped to matingly receive the at least one projecting portion of the second cooking plate to selectively fasten the first cooking plate to the second cooking plate.

20. (canceled)

21. The removable stovetop grill in accordance with claim 1, wherein the engagement features comprise:
a groove formed in the lip of the first cooking plate along the lateral coupling edge;
a lip portion formed on a bottom stovetop-facing surface proximate to the flat peripheral edge surface and corresponding to the groove formed in the lip of the first cooking plate that is sized to fit into the groove and cause the fluid seal between the flat peripheral edges of the first and second cooking plates.

22. The stovetop hibachi grill of claim 15, wherein the engagement features comprise:
a groove formed in the lip of the first cooking plate along the lateral coupling edge;
a lip portion formed on a bottom stovetop-facing surface proximate to the flat peripheral edge surface and corresponding to the groove formed in the lip of the first cooking plate that is sized to fit into the groove and cause the fluid seal between the flat peripheral edges of the first and second cooking plates.
